(19) United States
(12) Patent Application Publication
(10) Pub. No.: US 2026/0014906 A1
(43) Pub. Date: Jan. 15, 2026

(54) VEHICLE SEAT SUPPORT STRUCTURE

(71) Applicant: Faurecia Autositze GmbH, Hannover (DE)

(72) Inventors: Dimitri Unrau, Niedernwöhren (DE); Eric Koutchenkoff, Aubigny sur Nère (FR); Romain Viguier, Étampes (FR)

(73) Assignee: Faurecia Autositze GmbH, Hannover (DE)

(21) Appl. No.: 19/267,279

(22) Filed: Jul. 11, 2025

(30) Foreign Application Priority Data
Jul. 12, 2024 (DE) 10 2024 119 840.0

(51) Int. Cl. B60N 2/18; B60N 2/02; B60N 2/10

(52) U.S. Cl. CPC B60N 2/1814; B60N 2/02253; B60N 2/02258; B60N 2/10; B60N 2/1875

(57) ABSTRACT

The invention relates to a vehicle seat support structure (1). A seat cushion frame element (2) is supported by a front link (4) and a rear link (10). The rear link (10) is pivotally linked by a second rear link joint (11) to a vehicle seat base (8). The front link (4) is pivotally linked by a second front link joint (5) to a crank (6). The crank (6) is pivotally linked by a crank joint (7) to the vehicle seat base (8). A first actuator (18) is linked to the crank (6). An actuation of the first actuator (18) is in particular used for adjusting a tilt angle of the seat cushion frame element (2). A second actuator (19) is linked to the rear link (10). An actuation of the second actuator (19) is in particular used for adjusting the height of the seat cushion frame element (2).

### CROSS REFERENCE TO RELATED APPLICATIONS

This application claims priority to co-pending German Patent Application No. DE 10 2024 119 840.0 filed Jul. 12, 2024, the disclosure of which is hereby incorporated herein by reference in its entirety.

### FIELD OF THE INVENTION

The present invention relates to a vehicle seat support structure used in particular in a passenger compartment of a vehicle. The vehicle seat support structure is part of the vehicle seat. The vehicle seat support structure allows adjustments of the tilt angle and the height of the vehicle seat, in particular of the seat cushion. These adjustments are induced by electric actuators.

### BACKGROUND OF THE INVENTION

WO 2023/109028 A1 (corresponding to US patent application US 2024/0391361 A1) discloses a vehicle seat support structure allowing adjustments of the tilt angle of the vehicle seat. A rear end of a seat cushion frame element is pivotally linked to a vehicle seat base. The front end of the seat cushion frame element is pivotally linked by a first front link joint to a front end of the seat cushion frame element. The front link is pivotally linked by a second front link joint to a crank. The crank is pivotally linked by a crank joint to the vehicle seat base. For adjusting the tilt angle of the seat cushion element the crank is pivoted by an actuator. The actuator is embodied as an electric motor and a transmission. The transmission here is a toothed rack integrated into the crank, the toothed rack meshing with a pinion gear driven by the electric motor.

DE 10 2023 121 350 A1 (corresponding to US patent application US 2024/0343166 A1) discloses a vehicle seat support structure with a seat cushion frame in which the two lateral seat cushion frame elements are connected to each other via a front and a rear cross tube. The front cross tube is rigidly connected to the seat cushion frame elements, while the rear cross tube is rotatably connected to the seat cushion frame elements. The vehicle seat support structure has an adjustment mechanism for adjusting the height and inclination of the seat cushion frame, which is designed here as a five-link mechanism with five parallel axes of rotation. The five-link mechanism comprises a crank linked to an adapter that can be moved longitudinally along a seat rail. A front connecting strut is linked to the adapter in the end region facing away from the adapter. The other end of the front connecting strut is in turn linked to the associated seat cushion frame element. One end region of a rear connecting strut is also linked to the adapter, while the rear connecting strut is linked to the seat cushion frame element in the other end region by welding the rear connecting strut to the rear cross tube. A second actuator is used to adjust the height of the seat frame. The second actuator has an electric motor, a transmission, a spindle nut driven by the electric motor, and a spindle that can be extended in accordance with the rotation of the spindle nut. The second actuator connects the rear connecting strut directly to the adapter. The electric motor and the transmission are eccentrically linked to the rear connecting strut, while the spindle is linked to the adapter. Actuating the spindle drive via the electric motor causes the rear connecting strut to pivot, thereby changing the height of the seat frame, while at the same time causing a defined pivoting movement of the front connecting strut and of the crank. A first actuator comprises an electric motor, a transmission and a spindle drive formed by a spindle nut and a spindle. The first actuator is used to change an inclination of the seat cushion frame. The first actuator provides a length-adjustable coupling between the adapter and the front connecting strut. A change in the length of the spindle drive of the first actuator causes the seat cushion frame to pivot about the axis of rotation defined by the rotatable rear cross tube, thereby changing the inclination of the seat cushion frame. It is possible that the vehicle seat support structure has only a first actuator on one side or has first actuators on both sides. The first actuator is linked to the adapter offset from the linkage of the crank to the adapter. The first actuator is linked to the front connecting strut between the axis of rotation about which the front connecting strut and the seat cushion frame are rotated relative to each other and the axis of rotation about which the front connecting strut and the crank are rotated relative to each other.

DE 692 19 029 T2 (corresponding to granted U.S. Pat. No. 5,112,018 A) discloses a corresponding five-link mechanism. In one embodiment, one end of the crank is linked to a vehicle seat base, while the other end of the crank is linked to a seat cushion frame element. In another embodiment, the crank is designed as a crank lever with a first crank lever part and a second crank lever part. A crank joint arranged at the transition between these two crank lever parts is then rotatably mounted on the vehicle seat base. The front connecting strut is pivotably linked to the end region of the first crank lever part facing away from the crank joint. In contrast, the first actuator is linked to the end region of the second crank lever part facing away from the crank joint. Here too, the first actuator comprises a spindle drive. DE 692 19 029 T2 also discloses another embodiment in which the crank is not designed as a crank lever but as a swinging arm. In this embodiment, the rear connecting strut can then be designed as a rear connecting lever. For this embodiment, the connecting lever part not linked to the seat cushion frame part is connected to an actuator comprising a spindle drive.

US 2024/0075853 A1 also discloses a generic five-link mechanism. Here, the crank is designed as a crank lever. Here, the crank lever part to which the front connecting strut is not linked comprises a circumferential toothing in the end region facing away from the crank joint. The circumferential toothing meshes with a pinion driven by an electric motor via a transmission. The crank can thus be pivoted by driving the pinion.

Finally, CN 219 544 549 U discloses a vehicle seat support structure comprising a five-link mechanism, in which a crank designed as a swinging arm can be pivoted by means of a first actuator designed as an electric motor. The rear connecting strut can be pivoted via a rack and pinion drive. The rack of the rack and pinion drive is linked to the rear connecting strut at a location between the pivot bearings of the rear connecting strut. The rack extends laterally from the vehicle seat. A toothing arranged on the underside of the rack meshes with a pinion of the rack and pinion drive, the rack being driven by a motor comprising a transmission. The motor with the transmission is attached to a vehicle seat base. The longitudinal and driving axis of the motor extends parallel to the longitudinal direction of the vehicle.

Further prior art is known from WO 2024/067769 A1.

### SUMMARY OF THE INVENTION

With the new invention it is possible to provide a vehicle seat support structure which
allows adjustments of the height and of the tilt angle,
is improved with respect to the design space and the space available for integrating components as e.g. actuators, aggregates of an electric vehicle into the vehicle seat and/or of batteries of an electric vehicle below the seat,
is improved with respect to the avoidance of a contact of a recliner with the tracks and/or
is improved with respect to the provision of the structural robustness and the fulfillment of crash requirements.

A vehicle seat support structure comprises a seat cushion frame element. The seat cushion frame element in particular serves for (directly or indirectly) supporting a seat cushion and components and aggregates related to the seat cushion. Furthermore, a backrest frame element can be linked to the seat cushion frame element with an automatic or manual device for adjusting the angle between the seat cushion frame element and the backrest frame element. The seat cushion element is supported on a vehicle seat base which can be formed by one integral component or a fixed and rigid unit formed by a plurality of components. The vehicle seat base can be supported on the vehicle floor in a rigid fashion. Preferably, the vehicle seat base is supported with at least one degree of freedom on the vehicle floor. Preferably, the vehicle seat base is supported on rails fixed to the vehicle floor, the rails allowing a displacement of the vehicle seat base (and so the vehicle seat) in longitudinal direction of the vehicle.

The seat cushion frame element is supported on the vehicle seat base as follows:

The seat cushion frame element is supported (in particular at a front end of the seat cushion frame element) by a crank and a front link on the vehicle seat base. The crank is pivotally linked by a crank joint to the vehicle seat base. The front link is pivotally linked by a first front link joint to (in particular the front end of) the seat cushion frame element. Furthermore, the front link is pivotally linked by a second front link joint to the crank.

The seat cushion frame element is supported (in particular at its rear end) on the vehicle seat base by a rear link. The rear link is pivotally linked by a first rear link joint to (in particular the rear end of) the seat cushion frame element. Furthermore, the rear link is pivotally linked by a second rear link joint to the vehicle seat base.

The vehicle seat support structure comprises two actuators, namely a first actuator and a second actuator. The first actuator is connected to the crank for pivoting the crank about the crank joint relative to the vehicle seat base. The second actuator is connected to the rear link for pivoting the rear link about the second rear link joint relative the vehicle seat base.

The two actuators in particular serve for providing different functions: It is possible that the first actuator is actuated for changing a tilt angle of the seat cushion frame element. Instead, the second actuator can be actuated for adjusting the height of the seat cushion frame element. However, it is also possible that for adjusting the tilt angle and/or the height of the seat cushion frame element both the first actuator and the second actuator are actuated in a coordinated way. It is e.g. possible that when primarily actuating the second actuator for adjusting the height of the seat cushion frame element also the first actuator is actuated (e.g. to a reduced extend) for compensating a change of the tilting angle due to the actuation of the second actuator.

It is proposed that the bases of both the first actuator as well of the second actuator are supported on the vehicle seat base. For that aim, the bases of the first and second actuator are preferably pivotally linked (in particular at locations having a distance in longitudinal direction) to the vehicle seat base.

For one embodiment the first actuator applies a torque on the crank for pivoting the crank about the crank joint relative to the vehicle seat base. The torque is applied by a pinion gear driven by an electric motor which meshes with a toothed rack connected to or established by the crank. In this case, the toothed rack preferably has a toothed contour having an orientation in circumferential direction of the crank joint.

In one embodiment of the vehicle seat support structure the first actuator comprises an electric motor and a transmission. Here, the transmission is used for gearing-up or gearing-down the torque of the electric motor to the torque applied to the crank and/or for defining the ratio of the rotational angle of the driving gear driven by the electric motor and the rotational angle of the crank required for achieving the desired adjustment.

In one embodiment of the vehicle seat support structure the crank is embodied as a crank lever comprising a first crank lever part and a second crank lever part. In this case, the crank joint is arranged at the transition between the first and second crank lever parts. Preferably, the longitudinal axes of the crank lever parts form an obtuse angle. In this case, the front link can be pivotally linked by the second front link joint to the first crank lever part whereas the first actuator is connected to the second crank lever part for pivoting the crank about the crank joint relative to the vehicle seat base. The use of a crank lever comprising different crank lever parts can serve for gearing-up or gearing-down the force or torque provided by the electric motor to the force or torque applied to the crank for inducing the pivoting movement of the same. Furthermore, the use of a crank lever with two crank lever parts can be used for changing or inverting the movement on the hand of the driving element of the actuator and on the other hand of the front link at the second front link joint. The use of the crank lever comprising two lever parts can furthermore open new options of the integration of the supporting structure of the seat cushion frame element and the actuator(s) into the vehicle seat.

Preferably, the first actuator is connected to the second crank lever part by a first actuator joint. The first actuator joint allows a pivoting movement of the crank relative to the driving element of the first actuator.

In one embodiment the first actuator comprises an electric motor and a transmission. Here, the transmission can be embodied as toothed rack linked by the first actuator joint to the second crank lever part. The toothed rack then meshes with a pinion gear which is driven by the electric

Further features relate to the support of the rear end of the seat cushion frame element on the vehicle seat base:

In one embodiment, the second actuator applies a torque on the rear link for pivoting the rear link about the second rear link joint relative to the vehicle seat base. This torque is in particular applied for adjusting the height of the seat cushion frame element.

In one embodiment, the second actuator comprises an electric motor and a transmission.

Furthermore, it is possible that the rear link is embodied as a rear link lever which comprises a first rear link lever part and a second rear link lever part. The second rear link joint is in this case arranged at the transition from the first and second rear link lever parts. The rear end of the seat cushion frame element is pivotally linked by the first rear link joint to the first rear link lever part. The second actuator is connected to the second rear link lever part for pivoting the rear link about the second rear link joint relative to the vehicle seat base. This support of the rear end of the seat cushion frame element in particular allows an increase of the height of the sear cushion frame element (and also of the whole seat cushion frame element in some cases).

In one embodiment, the second actuator is connected to the second rear link lever part by a second actuator joint. The second actuator joint allows a pivoting relative movement between the driving element of the second actuator and the second rear link lever part.

It is possible that the second actuator comprises an electric motor and a transmission.

In this case, the transmission can be a toothed rack linked by the second actuator joint to the second rear link lever part. The toothed rack meshes with a pinion gear which is driven by the electric motor.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, exemplary embodiments of a vehicle seat support structure illustrated in the drawings are further explained and described.

FIG. 1 is a schematic diagram of a first embodiment of a vehicle seat support structure.

FIG. 2 is a schematic diagram of a second embodiment of a vehicle seat support structure.

FIG. 3 is a schematic diagram of a third embodiment of a vehicle seat support structure.

FIG. 4 is a longitudinal section of a vehicle seat support structure in particular showing the transmission of the first actuator.

FIG. 5 is a longitudinal section of the vehicle seat support structure of FIG. 4 in particular showing the transmission of the second actuator.

### DETAILED DESCRIPTION

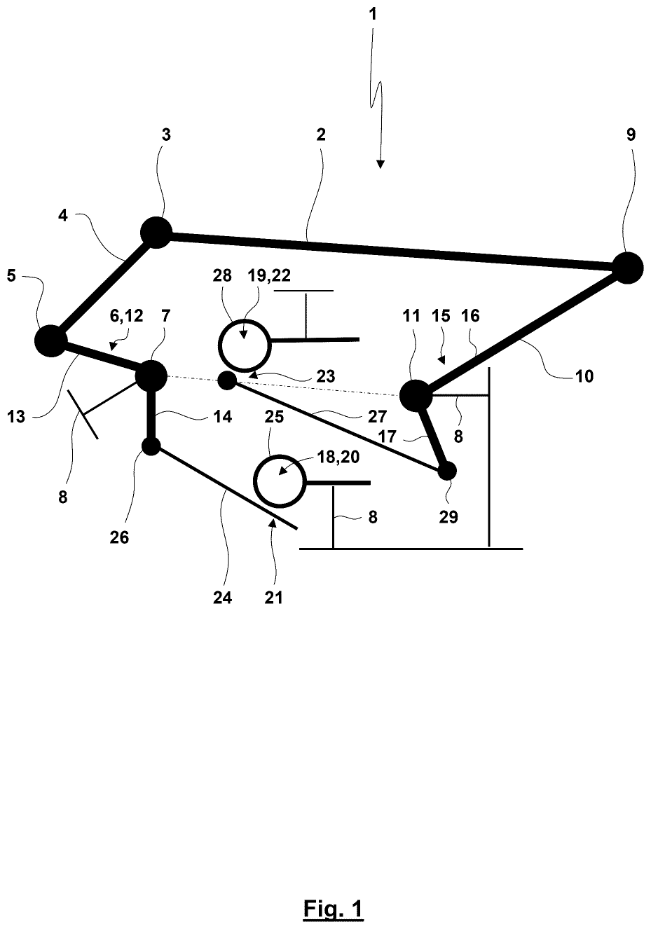

FIG. 1 illustrates a vehicle seat support structure 1 in a schematic view in particular showing the kinematics.

The vehicle seat support structure 1 comprises a seat cushion frame element 2.

At a front end the seat cushion frame element 2 is linked by first font link joint 3 to an upper end of a front link 4. The lower end of the front link 4 is pivotally linked by a second front link joint 5 to one end of a crank 6. The crank 6 is pivotally is linked by a crank joint 7 to a vehicle seat base 8. The vehicle seat base 8 is supported on the vehicle floor. The vehicle seat base 8 can be supported on longitudinal guiding rails of the vehicle floor allowing an (automatic or manual) adjustment of the longitudinal position of the vehicle seat.

At the rear end the seat cushion element frame element 2 is pivotally linked by a first rear link joint 9 to an upper end of a rear link 10. The lower end of the rear link 10 is pivotally linked by a second rear link joint 11 to the vehicle seat base 8.

For a fixed position of the crank 6 the seat cushion frame element 2, the front link 4 and the rear link 10 establish a four-bar chain wherein the front link 4 and the rear link 10 have different lengths and have different inclination angles.

For the embodiment shown in FIG. 1 the crank 6 is embodied as a crank lever 12 comprising a first crank lever part 13 and a second crank lever part 14. The crank joint 7 is arranged at a transition between the first and second crank lever parts 13, 14.

For the embodiment shown in FIG. 1 also the rear link 10 is embodied as a rear link lever 15 comprising a first rear link lever part 16 and a second rear link lever part 17. The second rear link joint 11 is arranged at a transition between the first and second rear link lever parts 16, 17.

For an adjustment of the tilt angle and the height the crank 6 and the rear link 10 can be rotated independently on each other by a first actuator 18 and a second actuator 19. The first actuator 18 comprises an electric motor 20 and a transmission 21 and the second actuator 19 comprises an electric motor 22 and a transmission 23.

For the embodiment shown in FIG. 1, the transmission 21 of the first actuator 18 comprises a toothed rack 24. The toothed rack 24 is connected by a first actuator joint 26 to the end region of the second crank lever part 14. The toothed rack 24 of the first actuator 18 meshes with a pinion gear 25 of the first actuator 19. The pinion gear 25 is driven by the electric motor 20 of the first actuator 18. The movement of the pinion gear 25 leads to a displacement of the toothed rack 24 transmitted by the first actuator joint 26 to a rotational movement of the crank 6.

For the embodiment shown in FIG. 1, the transmission 23 of the second actuator 19 comprises a toothed rack 27 and a pinion gear 28. The toothed rack 27 is pivotally linked by a second actuator joint 29 to an end region of the second rear link lever part 17. The pinion gear 28 is driven by the electric motor 22 of the second actuator 29.

For the embodiment shown in FIG. 1, the electric motors 20, 22 of the actuators 18, 19 are both supported and fixed on or pivotally linked to the vehicle seat base 8 at position having a distance from each other in longitudinal direction.

The vehicle seat support structure 1 shown in FIG. 1 allows the following adjusting movements:
a) By fixing the position of the first actuator 18 (and so of the crank 6) and by an actuation of the second actuator 19 the rear link 10 can be pivoted about the second rear link joint 11. This pivoting movement of the rear link 10 causes a pivoting movement of the front link 4 into the same direction which again leads to an increase of the height of the seat cushion frame element 2. Depending on the lengths of the front link 4 and the rear link 10 the tilt angle of the seat cushion frame element 2 can remain the same or change to a small extend.
b) When fixing the second actuator 19 (and so the rear link 10) and by actuating the first actuator 18 the crank 6 is pivoted about the crank joint 7. The pivoting movement of the crank 6 leads to a change of the height of the second front link joint which also leads to a s change of the height of the front link 4. For allowing the change of the height of the front link 4 the seat cushion element 2 is pivoted about the first rear link joint 9 (which does not change its position). During these movements of the front link 4 and the seat cushion frame element 2 the front link 4 can also be pivoted to a small extend. The actuation of the first actuator 18 with fixed second actuator 19 leads to a change of the tilt angle of the seat cushion frame element 2.
c) It is possible that the first actuator 18 and the second actuator 19 are actuated simultaneously in a manual or automated fashion. Is e.g. possible that for achieving a pure lifting movement of the seat cushion frame element 2 the actuation of the second actuator 19 is accompanied by an actuation of the first actuator 18 for counteracting any undesired tilting movement of the seat cushion frame element 2.

It is possible that the actuators 18, 19 are arranged and/or extend in parallel longitudinal vertical planes. The actuators 18, 19 can have a longitudinal overlap but a lateral distance from each other. It is possible here that the electric motor 20 of the first actuator 18 is arranged behind the electric motor 22 of the second actuator 19 when seeing in longitudinal direction.

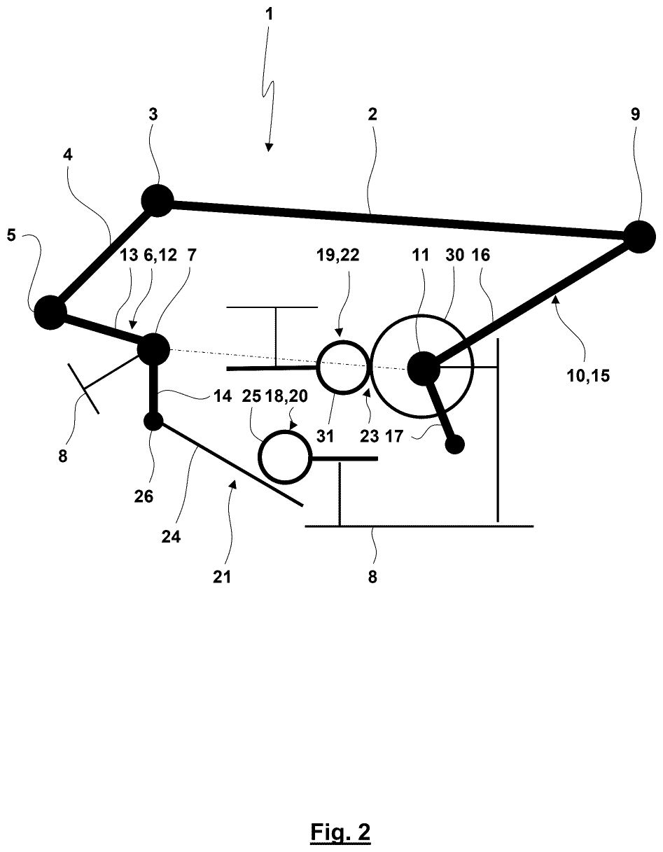

The embodiment shown in FIG. 2 generally corresponds to the embodiment of FIG. 1. However, here the second actuator 19 has a different design: The rear link 10 comprises or fixedly supports a gear 30 rotating together with the rear link 10 about the second rear link joint 11. In this case, the second actuator 19 comprises a driving gear 31 driven by the electric motor 22 and meshing with gear 30. The meshing gears 30, 31 transmit the torque provided by the electric motor 22 to the rear link 10. In this case, the rear link 10 does not necessarily comprise the second rear link lever part 17.

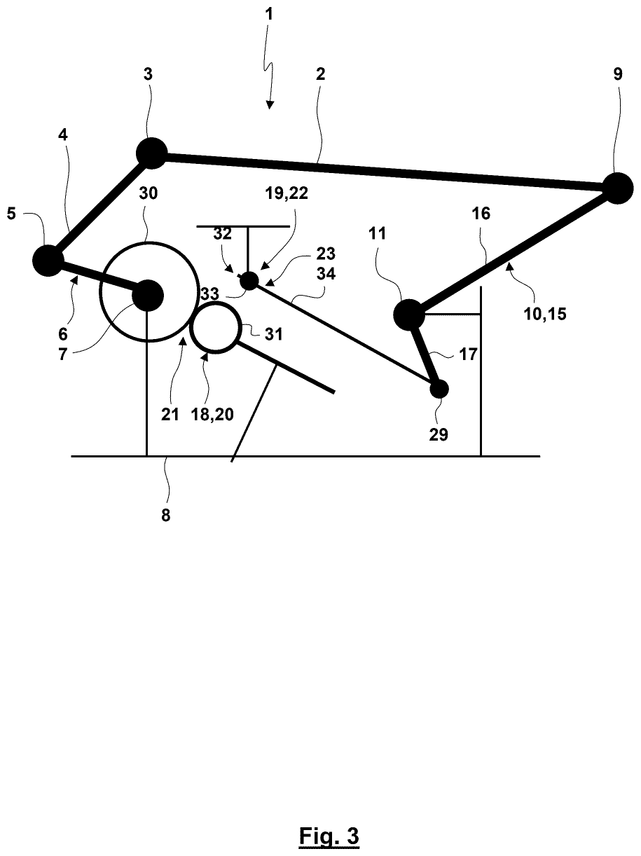

The embodiment shown in FIG. 3 generally corresponds to the embodiment of FIG. 1. However, here the first actuator 18 comprises a transmission 21 with a gear 30 fixedly connected to and rotating with the crank 6. The gear 30 meshes with a driving gear 31 driven by the electric motor 20 of the first actuator 18. In this case the crank 6 is not embodied as a crank lever 12 so that the crank 6 does not comprise the second crank lever part 14.

For the embodiment in FIG. 3, the second actuator 19 comprises a transmission 23 being a spindle drive 32. The spindle drive 32 comprises a spindle nut 33 which meshes with a spindle 34. The spindle 34 is pivotally linked by the second actuator joint 29 to the second rear link lever part 17. The spindle nut 33 is rotated by the electric motor 22 of the second actuator 19. For establishing the spindle drive 32 the spindle nut 33 is axially fixed but rotatable whereas the spindle 34 is fixed against a rotation but able to be displaced relative to the spindle nut 33.

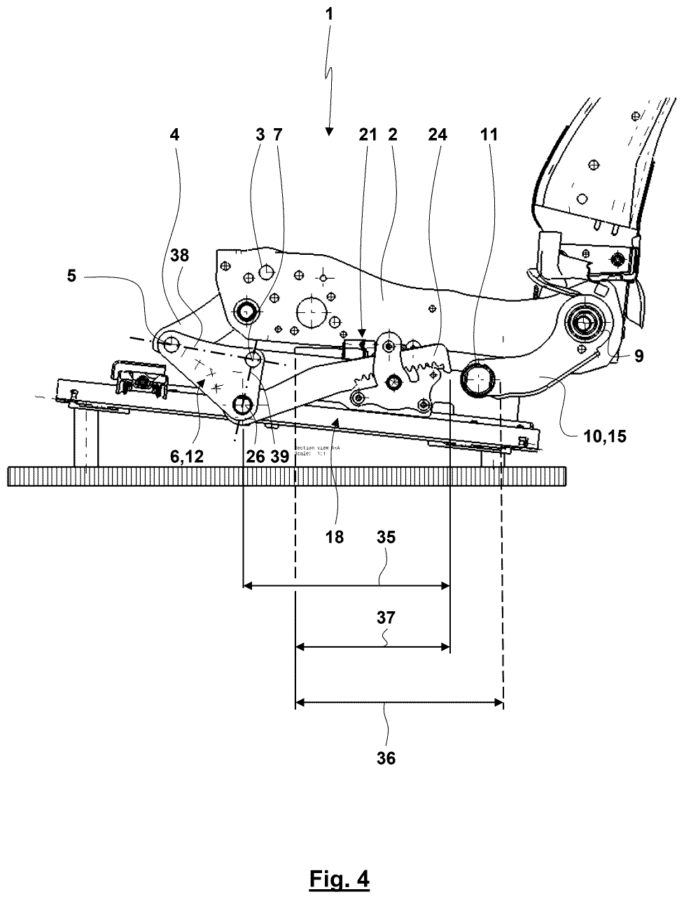

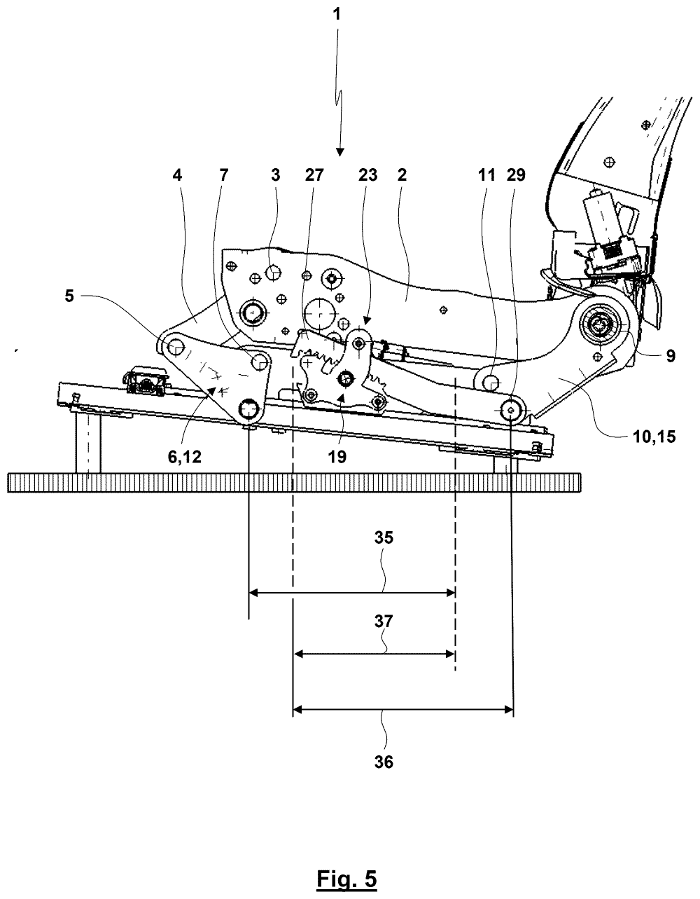

FIG. 4 is a longitudinal vertical sectional view showing the first actuator 18 and the transmission 21 whereas FIG. 5 is a longitudinal vertical sectional view showing the second actuator 19 and the transmission 23. The longitudinal vertical sections of FIGS. 4 and 5 and the actuators 18, 19 are offset to each other in lateral direction (so vertical to the drawing planes of FIGS. 4 and 5). It is possible that the actuators 18, 19 are arranged on different sides of the vehicle seat. Here, it is possible that corresponding seat cushion frame elements are arranged on both sides of the vehicle seat wherein the actuators 18, 19 are then arranged adjacent and/or linked to a respective adjacent seat cushion frame element. It is further possible, that the cranks 6 on the different sides of the vehicle seat driven by the first actuator 18 are linked to each other by a connecting rod extending in transverse direction. Correspondingly, the rear links 10 on the different sides of the vehicle seat actuated by the second actuator 19 can be coupled to each other by a connecting rod extending in transverse direction.

For the embodiment in FIGS. 4 and 5 the crank lever 12 with the crank lever parts 13, 14 and the rear link lever 15 with the rear link lever parts 16, 17 have no dedicated lever parts but have a geometry being triangular in a first approximation. Here, the crank joint 7, the second front link joint 5 and the first actuator joint 26 are arranged at the corners of the triangular crank lever 12. In this case a longitudinal axis 38 of the first crank lever part 13 is defined by the connection between the second front link joint 5 and the crank joint 7. A longitudinal axis 39 of the second crank lever part 14 is defined by the connection of the crank joint 7 and the first actuator joint 26.

The first rear link joint 9, the second rear link joint 11 and the second actuator joint 29 are arranged at the corners of the triangular rear link lever 15.

As can be seen in FIG. 4, the first actuator 18 with the electric motor 20 and the transmission 21 (here the toothed rack 27) with the pinion gear (not shown) extend in a longitudinal region 35. The longitudinal region 35 can e.g. start at the first actuator joint 26 and end at the rear end of the toothed rack 27 whereas the pinion gear and the electric motor 20 are arranged between the start and the end when seen in longitudinal direction.

As can be seen in FIG. 5, the second actuator 19 with the electric motor 22 and the transmission 23 (here also a toothed rack 27) with a pinion gear (not shown) extend in a longitudinal region 36. Here, the longitudinal region 36 starts at the end of the toothed rack 27 and ends with the second actuator joint 29 whereas the pinion gear and the electric motor 22 are arranged between the start and the end when seen in longitudinal direction. The longitudinal regions 35, 36 extend laterally of each other with a gap there between. The longitudinal regions 35, 36 have an overlap 37 in longitudinal direction.

The electric motor 20 of the first actuator 18 is preferably arranged behind the electric motor 22 of the second actuator 19.

The links 4, 10, the seat cushion frame element 2 and the crank 6 can have any design, in particular a design of a bar, strut, rod, support, hinged column and the like. For increasing the stiffness they can have any cross section with an increased geometrical moment of inertia. These components can e.g. be manufactured by use of a (massive) forming process.

The first actuator 18 and/or the second actuator 19 may comprise a transmission 21 respectively a transmission 23 having one of the following designs:
a) The transmission may comprise a gear 30 and a driving gear 31, the gears 30, 31 meshing with each other. Dependent on the angle the gears 30, 31 are rotated for inducing the required adjustment, the gears 30, 31 might have a toothing over the whole circumference (circumferential extension of the toothing of) 360° or only over a part of the circumference (circumferential extension of the toothing less than) 360°. In this case, the toothing has a (semi-) circular contur with a constant radius from the rotational axis of the gears 30, 31. In this case, the main body of the gears 30,31 carrying the teeth might be circular or might have the shape of a pitch circle or any other reduced shape providing the toothing and the required rotational bearing lug. For this embodiment of the transmission 21, 23 the toothing of the gears 30,31 is an outer toothing.
b) It is possible that the toothing of the component linked to the actuator joint 26, 29 is an inner toothing. The inner toothing can e.g. be formed by an elongated slot of a disk which rotates about the crank joint 7 in the case of the transmission 21 or rotates about the second rear link joint 11 in the case of the transmission 23. In this case the electric motor 20, 22 drives a pinion gear 28 meshing with the inner toothing. The pinion gear 28 can for this purpose be arranged within the elongated slot. The elongated slot extends in circumferential direction about the rotational axis of the crank joint 7 respectively the second rear link joint 11. In this case the semicircular toothing can also be considered to form a toothed rack with a semi-circular toothing which meshes with the pinion gear (cp. also WO 2023/109028 A1 and WO 2024/067769 A1).
c) It is possible that at least one transmission 21, 23 comprises a (non-semi-circular or non-circular) toothed rack 24, 27 meshing with a pinion gear 25, 28. Whereas for the embodiment described under b) a rotational movement is induced about a fixed rotational axis, the rotation of the pinion gear 25, 28 along the toothed rack 24, 27 leads to a kind of telescopic movement of the transmission 21, 23 transferred by the actuator joint 26, 29 to the crank 6 respectively to the rear link 10. Here, the couture of the toothed rack 24, 27 might be straight or might have any curvature.
d) It is also possible that at least one of the transmissions 21, 23 comprises a spindle drive 32 with a spindle nut 33 and a spindle 34. The spindle drive 32 also leads to a telescopic actuating movement of the transmission 21, 23.

For the shown embodiments and for the concepts of the transmission 21 any one of the above options a) to d) can be used. Also for the transmission 23 any one of the options a) to d) can be used. Accordingly, for the transmissions 21, 23 the same types of designs a) to d) as described above or different types of designs can be used.

It is possible that only one single first actuator 18 and only one single second actuator 19 is used. In this case, the actuators 18, 19 can be located at any position in lateral direction of the vehicle seat, in particular in a middle position or at a lateral outer position. In this case the actuator 18, 19 might only transfer the force or torque for the adjustment to the seat cushion frame element 2 on one side of the vehicle seat. The torque or force can then be transferred to a seat cushion frame element on the other side of the vehicle seat by the seat cushion frame structure or a connecting rod.

It is also possible that one of the actuators 18, 19 is a single actuator as described before whereas the other actuator 19, 18 comprises two second actuators 18a, 18b respectively 19a, 19b. In this case, the pair of first actuators 18a, 18b respectively the pair of second actuators 19a, 19b can be arranged on different sides of the vehicle seat and can each transfer its actuator force or torque to the respective seat cushion frame element one of the different sides of the vehicle seat.

Finally, it is also possible that both a pair of first actuators 18a, 18b as well as a pair of second actuators 19a, 19b is used.

In the case that at least for one actuator 18, 19 a pair of actuators is used, the electric motors 20a, 20b respectively 22a, 22b can be controlled in a synchronized way for producing the same displacements, forces and torques on both sides of the vehicle seats. Alternatively or additionally the movement of the pair of actuators can be coupled to each other by a transverse connecting rod or a different mechanical coupling mechanism.

Many variations and modifications may be made to the preferred embodiments of the invention without departing substantially from the spirit and principles of the invention. All such modifications and variations are intended to be included herein within the scope of the present invention, as defined by the following claims.

We claim:

1. A vehicle seat support structure comprising
a) a vehicle seat base,
b) a seat cushion frame element,
c) a crank, the crank being pivotally linked by a crank joint to the vehicle seat base,
d) a front link, the front link being pivotally linked by a first front link joint to the seat cushion frame element and being pivotally linked by a second front link joint to the crank,
e) a rear link, the rear link being pivotally linked by a first rear link joint to the seat cushion frame element and being pivotally linked by a second rear link joint to the vehicle seat base,
f) a first actuator connected to the crank for pivoting the crank about the crank joint relative to the vehicle seat base and
g) a second actuator connected to the rear link for pivoting the rear link about the second rear link joint relative to the vehicle seat base,
h) bases of the first and second actuator being supported on the vehicle seat base,
i) the first actuator comprising a first transmission with a first pinion gear meshing with a first toothed rack, the first toothed rack extending in a first longitudinal region,
j) the second actuator comprising a second transmission with a second pinion gear meshing with a second toothed rack, the second toothed rack extending in a second longitudinal region and
k) the first and second toothed racks are laterally offset from each other and the first and second longitudinal regions having an overlap in a longitudinal direction.

2. The vehicle seat support structure of claim 1, wherein the first actuator applies a torque on the crank for pivoting the crank about the crank joint relative to the vehicle seat base.

3. The vehicle seat support structure of claim 2, wherein the first actuator comprises a first electric motor and the first transmission.

4. The vehicle seat support structure of claim 1, wherein
a) the crank is embodied as a crank lever comprising a first crank lever part and a second crank lever part,
b) the crank joint is arranged at a transition between the first and second crank lever parts,
c) the front link is pivotally linked by the second front link joint to the first crank lever part and
d) the first actuator is connected to the second crank lever part for pivoting the crank about the crank joint relative to the vehicle seat base.

5. The vehicle seat support structure of claim 4, wherein the longitudinal axes of the crank lever parts forming an obtuse or acute angle.

6. The vehicle seat support structure of claim 4, wherein the first toothed rack is linked by a first actuator joint to the second crank lever part and the first pinion gear is driven by a first electric motor.

7. The vehicle seat support structure of claim 1, wherein the second actuator applies a torque on the rear link for pivoting the rear link about the second rear link joint relative to the vehicle seat base.

8. The vehicle seat support structure of claim 7, wherein the second actuator comprises a second electric motor and the second transmission.

9. The vehicle seat support structure of claim 8, wherein
a) the rear link is embodied as a rear link lever comprising a first rear link lever part and a second rear link lever part,
b) the second rear link joint is arranged at a transition between the first and second rear link lever parts,
c) the seat cushion frame element is pivotally linked by the first rear link joint to the first rear link lever part and
d) the second actuator is connected to the second rear link lever part for pivoting the rear link about the second rear link joint relative to the vehicle seat base.

10. The vehicle seat support structure of claim 9, wherein the second toothed rack is linked by a second actuator joint to the second rear link lever part.
